(19) United States
(12) Patent Application Publication
(10) Pub. No.: US 2026/0010045 A1
(43) Pub. Date: Jan. 8, 2026

(54) ELECTRODEPOSITION SMART WINDOW

(71) Applicant: Soonchunhyang University Industry Academy Cooperation Foundation, Asan-si (KR)

(72) Inventor: Cheon Woo Moon, Asan-si (KR)

(21) Appl. No.: 19/259,308

(22) Filed: Jul. 3, 2025

(30) Foreign Application Priority Data
Jul. 3, 2024 (KR) 10-2024-0087327

(51) Int. Cl. G02F 1/1523; G02F 1/1506; G02F 1/153

(52) U.S. Cl. CPC G02F 1/1523; G02F 1/1506; G02F 1/153

(57) ABSTRACT

The present disclosure relates to an electrodeposition smart window, and more particularly, to an electrodeposition smart window which is excellent in terms of electrical energy efficiency because it is possible to greatly change transmittance of light even with less current compared to a comparative smart window, and because the transmittance of incident light is uniformly decreased across the entire wavelengths when voltage is applied, and black is excellently implemented, so that light may be effectively blocked or transmitted, and it is very excellent in terms of usability as a smart window.

### CROSS-REFERENCE TO RELATED APPLICATION

This application claims priority to and the benefit of Korean Patent Application No. 10-2024-0087327, filed on Jul. 3, 2024, the disclosures of which is incorporated herein by reference in its entirety.

### TECHNICAL FIELD

The present disclosure relates to an electrodeposition smart window, and more particularly, to an electrodeposition smart window which is excellent in terms of electrical energy efficiency because it is possible to greatly change transmittance of light even with less current compared to a comparative smart window, and because the transmittance of incident light is uniformly decreased across the entire wavelengths when voltage is applied, and black is excellently implemented, so that light may be effectively blocked or transmitted, and it is very excellent in terms of usability as a smart window.

### RELATED ART

Generally, a smart window means a window that is configured to be turned on and off, and changes the light transmittance when voltage is applied, thereby controlling the amount of light or heat passing therethrough. That is, the smart window is provided to be changed to a transparent, opaque or translucent state by voltage, and is also called a transmittance variable glass, a dimming glass or a smart glass.

Also, the smart window may be used as partitions of an indoor space or as skylights arranged in an opening of a building, may be used as a highway sign, a bulletin board, a score board, a clock or an advertising screen, and may be used as windows or sunroofs of a car, a bus, an aircraft, a ship or a train.

The smart window is classified into liquid crystal display (LCD), suspended particle display (SPD), electrochromic (EC) glass, photochromic (PC) glass, thermos-chromic (LTC) glass, and depending on the type of material that represents functionality. As the smart window is gaining attention as next-generation high-functionality and high-value-added products, advanced companies and related research institutions are driving development by introducing a huge budget.

### SUMMARY

An example smart window is generally manufactured using a polymer dispersed liquid crystal (PDLC), and has a structure in which a fine liquid crystal (LC) in a polymer matrix is dispersed by injecting a polymer dispersed liquid crystal between a pair of glass substrates. However, in the case of a smart window using the liquid crystal display (LCD), power consumption is greatly generated when driving for a long time.

Also, in the case of an example suspended particle display (SPD) smart window technology, the thickness becomes thick or the transmission efficiency is low by using a transparent electrode having a multilayer structure. Another example smart window technology includes a polymer dispersed liquid crystal device.

In addition, it may be said that it is essential to adjust the transmittance of light itself in order to efficiently operate solar energy, which is eco-friendly energy. In particular, it may be said that it is a very important task in smart window research to implement excellent black by controlling the transmittance in the entire wavelength range rather than just in a specific wavelength range. However, in the case of a polymer dispersed liquid crystal, the transparency can be controlled because they operate in a way that scatters light, but the performance of blocking the transmission of light itself is insufficient.

Therefore, it is possible to efficiently change the transmittance of light with less electric energy, thereby achieving excellent power efficiency, and at the same time, excellent black, thereby effectively blocking light, and thus developing a very excellent smart window in terms of its utilization.

Aspects of the present disclosure provide a smart window in which the transmittance of the smart window may be greatly adjusted even though the use of less electric energy and thus the power efficiency is excellent, and at the same time, the black is excellent to be implemented when voltage is applied, and effective light blocking is possible, so it is excellent in terms of environmental and usability aspects.

Aspects of the present disclosure provide an electrodeposition smart window, which include a substrate, and an electrochromic layer formed on the substrate, and wherein the electrochromic layer includes a nanoparticle layer including nanoparticles electrodeposited on the substrate when voltage is applied.

In addition, the nanoparticle layer may be configured such that an average radius of the nanoparticles is 20 to 120 nm.

In addition, the nanoparticle layer may be configured such that an average distance between the nanoparticles is greater than twice and less than or equal to four times an average radius of the nanoparticles.

In addition, the nanoparticles may include one or more selected from the group consisting of Zn, Ag, Cu, Bi, and Pb.

In addition, the electrodeposition smart window may further include a dendrite formed inside or on the nanoparticle layer.

In addition, the dendrite may be a porous structure.

In addition, the dendrite may be one or more selected from the group consisting of Zn, Ag, Cu, Bi, Pb and oxides of Zn, Ag, Cu, Bi, and Pb.

In addition, the dendrite may be configured such that its average short axis length is 33 nm or more and 175 nm or less.

In addition, the substrate may include a transparent base material; and a transparent conductive material coated on the transparent base material.

In this case, the transparent base material may be one or more selected from the group consisting of glass, polyester (PET), and polyether sulfone (PES), and the transparent conductive material may be one or more selected from the group consisting of InSnO (ITO), InZnO, ZnO, InZnSnO, TiInZnO, NiInZnO, AZO(Al-doped ZnO), BZO(B-doped ZnO), and Ga-doped ZnO (GZO).

In addition, the substrate may further include inert metal nanoparticles coated on the transparent conductive material.

In this case, the inert metal nanoparticles may be one or more selected from the group consisting of Pt, Au, Ru, Rh, Pd, Os, and Ir.

In addition, the transparent conductive material may have a thickness of 50 to 350 nm, and the electrochromic layer may have a thickness of 10 to 1000 nm.

In addition, the electrochromic layer may include an electrolyte layer, and the electrolyte layer may include a solvent and one or more selected from the group consisting of Zn²⁺, Ag⁺, Cu²⁺, Bi³⁺, and Ph²⁺.

In addition, the electrolyte layer may include Zn(CH₃COO)₂, ZnA₂, and BCH₃COO.

Here, ligand A is one or more selected from the group consisting of F, Cl, Br, and ligand B is one or more selected from the group consisting of Li, Na, and K.

In addition, the Zn(CH₃COO)₂ may have a concentration of 10 to 500 mM, and the ZnA₂ may have a concentration of 10 to 500 mM.

In addition, the Zn(CH₃COO)₂ may have a concentration of 200 to 500 mM, and the ZnA₂ may have a concentration of 200 to 500 mM.

In addition, the electrolyte layer may further include one or more selected from the group consisting of polyvinylpyrrolidone (PVP), cetyltrimethylammonium bromide (CTAB), cetyltrimethylammonium chloride (CTAC), polyethylene glycol (PEG), ethylenediaminetetraacetic acid (EDTA), and bovine serum albumin (BSA).

In addition, a current density applied until a transmittance reaches 10% at 400 to 800 nm may be always lower than that of the case of a metal thin film including the same amount of Zn, Ag, Cu, Bi, and Pb.

In addition, the applied voltage may be −1 to 1.5 V.

The present disclosure can provide a smart window in which the transmittance may be greatly adjusted even though the use of less electric energy and thus the power efficiency is excellent.

In addition, at the same time, the black is excellent to be implemented when the voltage is applied, and effective light blocking is possible, so that a smart window with excellent environmental and usability aspects can be provided.

### BRIEF DESCRIPTION OF THE DRAWINGS

FIGS. 1A to 1C are photographs taken by SEM after voltage is applied to an electrodeposition smart window according to an embodiment of the present disclosure. FIG. 1A shows a case where a Pt NPs SAM electrode is used, FIG. 1B shows a case where a spray-coated Pt NPs electrode is used, and FIG. 1C shows a case where a Pt NPs SAM electrode is used, but PVP is further included in the electrolyte.

FIGS. 2A to 2D each shows transmittance for each wavelength according to time when voltage is applied to an electrodeposition smart window according to an embodiment of the present disclosure. FIG. 2A shows a case where a Pt NPs SAM electrode is used, FIG. 2B shows a case where a spray-coated Pt NPs electrode is used, and FIG. 2C shows a case where a Pt NPs SAM electrode is used but PVP is additionally included in the electrolyte, and FIG. 2D shows a case where a bare ITO electrode is used.

FIG. 3 shows a current density applied over time in the electrodeposition experiments of FIGS. 1A to 1C.

FIG. 4 shows transmittances over time for light having wavelengths of 600 nm and 1000 nm for each electrode in the electrodeposition experiments of FIGS. 1A to 1C, and the electrodes corresponding to the respective graphs are the same as those shown in FIG. 3.

FIG. 5 shows current density values applied until transmittances reach 10% for light of each wavelength band in the electrodeposition experiments of FIGS. 1A to 1C, and the electrodes corresponding to the respective graphs are the same as those shown in FIG. 3.

FIG. 6 shows a current density value applied until transmittance reaches 10% for light of each wavelength band in the electrodeposition experiment of FIG. 2D using bare ITO as an electrode.

FIG. 7 shows an example in which hemispherical Zn nanoparticles are arranged on a virtual substrate of 400 nm×400 nm in performing FDTD simulation.

FIG. 8 shows the transmittance (solid lines) compared to the transmittance (dotted lines) of a 15 nm-thick Zn thin film when the same amount of Zn as in the 15 nm-thick Zn thin film is uniformly arranged in the form of 12 to 62 nanoparticles.

FIG. 9 shows the transmittance (solid lines) compared to the transmittance (dotted lines) of a 40 nm-thick Zn thin film when the same amount of Zn as in the 40 nm-thick Zn thin film is uniformly arranged in the form of 12 to 62 nanoparticles.

FIG. 10 shows the reflectance of nanoparticles having the same amount of Zn as in a 15 nm-thick Zn thin film in performing the FDTD simulation as shown in FIG. 7.

FIG. 11 shows the reflectance of nanoparticles having the same amount of Zn as in a 40 nm-thick Zn thin film in performing the FDTD simulation as shown in FIG. 7.

FIG. 12 is a drawing showing a volume absorption mapping of light in performing the FDTD simulation as shown in FIG. 7.

FIG. 13 shows the results of performing an electric field profile analysis in the case of the FDTD simulation of FIG. 12.

FIG. 14 shows the results of performing the X-ray diffraction test on each deposited nanoparticle after depositing the nanoparticles on each substrate at a charge density of 267 mC/cm², as in the case of FIGS. 1A-1C.

FIG. 15 shows a measurement of the transmittance of the nanoparticle array having the same amount of Zn as in a 15 nm-thick Zn thin film in the FDTD simulation when 20% of the outer radius of each nanoparticle is replaced with ZnO.

FIGS. 16A to 16C are photographs taken by using a scanning electron microscope (SEM) of a state in which nanoparticles are formed on a substrate by applying voltage to an electrodeposition smart window according to an embodiment of the present disclosure. FIG. 16A shows a Pt NPs SAM electrode, FIG. 16B shows a spray-coated Pt NPs electrode, and FIG. 16C shows a case in which PVP is further included in an electrolyte.

FIGS. 17A to 17C show a change in transmittance over deposition time for each wavelength when the electrodeposition is performed under the same conditions as FIGS. 16A, 16B, and 16C, respectively.

FIG. 18 represents a current density applied over time in the electrodeposition experiment of FIGS. 16A-16C.

FIG. 19 shows the transmittance over time with respect to light having wavelengths of 600 nm and 1000 nm for each electrode in the electrodeposition experiments of FIGS. 16A-16C, and the electrodes corresponding to the respective graphs are the same as those shown in FIG. 18.

FIG. 20 shows a current density value applied until the transmittance reaches 10% for light of each wavelength band in the electrodeposition experiments of FIGS. 16A-16C, and the electrode corresponding to each graph is the same as shown in FIG. 18.

FIG. 21 shows the results of conductive-atomic force microscopy (c-AFM) when the electrodeposition is performed with a Pt NPs SAM electrode for 30 seconds in FIGS. 16A-16C. Part a of FIG. 21 shows a mapping of a surface height, (b) shows a mapping of a surface current using an external bias of 9V, and (c) shows an overlap of (a) and (b).

FIG. 22 shows the results of performing the X-ray diffraction test on each deposited nanoparticle after depositing the nanoparticles on each substrate at a charge density of 267 mC/cm², as in the case of FIGS. 16A-16C.

FIG. 23 is a schematic diagram of a growth model of scenarios 1 to 3 in performing FDTD simulation.

FIG. 24 shows the transmittance by wavelength according to the relative charge density (charge density corresponding to the electrodeposition configuration/charge density of the 40 nm thin film) for each scenario of FIG. 23.

FIG. 25 shows a reduction in transmittance according to a relative charge density at 550 nm compared to a case of a uniform thin film for each scenario of FIG. 23.

FIG. 26 shows a structure for each case and a configuration thereof for FDTD simulation of a dendrite structure.

FIG. 27 shows transmittance by wavelength for each case of FIG. 26.

FIG. 28 is a graph showing the electric field component mapping and absorption mapping performed for measuring the surface plasmon resonance phenomenon for case 1, case 2, and case 3 of FIG. 26 from the left in order.

FIG. 29 is a photograph taken by AFM after applying voltage to an electrodeposition smart window according to an embodiment of the present disclosure.

FIG. 30 is a photograph taken by AFM after applying voltage to an electrodeposition smart window according to an embodiment of the present disclosure.

### DETAILED DESCRIPTION OF THE EMBODIMENTS

Hereinafter, embodiments of the present disclosure will be described in detail so that those skilled in the art can easily carry out the present disclosure.

The present disclosure may be implemented in various different forms and is not limited to the embodiments described herein.

As described above, the example smart window has been mainly used in a method of adjusting the transparency of light by scattering light using a polymer. However, power consumption of such a smart window is greatly generated when driving for a long time, and although the transparency can be controlled but the performance of blocking the transmission of light itself is insufficient, so its usability was very low in the field of controlling or blocking solar energy and utilizing it.

Therefore, aspects of the present disclosure provide an electrodeposition smart window including a substrate and an electrochromic layer formed on the substrate, and the electrochromic layer includes a nanoparticle layer including nanoparticles electrodeposited on the substrate when voltage is applied. Accordingly, the transmittance of the smart window may be adjusted to a large extent even though the use of less electric energy compared to a comparative smart window, and thus the power efficiency is excellent, and at the same time, the black is excellent to be implemented when the voltage is applied, and effective light blocking is possible, so it is excellent in terms of environmental and usability aspects.

Specifically, an electrodeposition smart window, which is a subject of the present disclosure, will be described.

The smart window is a window in which properties thereof are changed in a specific situation, and the smart window according to the present disclosure has the nanoparticle layer including nanoparticles upon application of a voltage, and thus the transmittance of light is changed. In this case, the nanoparticle layer is formed on the substrate and formed inside the electrochromic layer. More specifically, the nanoparticles formed on the substrate absorb the light transmitted therethrough, thereby reducing the transmittance of the light. In this case, the light is more strongly absorbed with the surface plasmon phenomenon generated among the surface of the nanoparticle in the part which is adjacent to substrate, and thus the transmittance is excellent in terms of reduction.

After the nanoparticles are formed, when the counter voltage is applied, the formed nanoparticles are decomposed again, and the transmittance is restored again, and the smart window returns to a transparent state. That is, depending on the direction, time, and intensity of the voltage application, the nanoparticles are deposited or decomposed, so the transmittance of the smart window may be freely adjusted. In particular, in the case of a comparative smart window using a polymer such as PDLC, in order to maintain a specific transparency, a power loss is largely caused by continuously supplying a current, but in the case of an electrodeposition smart window according to the present disclosure, when voltage is applied until a target transmittance is achieved, the continuous supply of current is not required thereafter, and thus the electric efficiency is excellent compared to that of the comparative smart window.

More specifically, the nanoparticles may include one or more selected from the group consisting of Zn, Ag, Cu, Bi, Pb, and oxides thereof, and preferably may include Zn. In this case, when the nanoparticles include Zn, the transmittance may be adjusted to a large extent even with less electric energy, compared to the other cases, so that electrical efficiency may be better, and the transmittance may be uniformly reduced across the entire wavelength bands during deposition, so that the black may be better implemented.

In addition, more specifically, the nanoparticle layer to be formed may be 5 to 1000 nm. Also, in the nanoparticle layer, the nanoparticles may occupy 50 volume %. In this case, when the thickness of the nanoparticle layer is less than 5 nm, sufficient optical transmission blocking does not occur, so that it may be disadvantageous in terms of driving of the smart window, and in addition, when the thickness of the nanoparticle layer is greater than 1000 nm, the amount of charge required for the oxidation-reduction process for the ions used for making the electrodeposited material becomes excessive, so that the switching efficiency compared to the optical transmittance control may be disadvantageous.

More specifically, the substrate may be used without limitation as long as it is usually a substrate that may be used in the smart window, but preferably, a transparent and conductive base material may be used. In embodiments, as a transparent and conductive base material, the transparent base material may be coated with a transparent conductive material. In this case, the transparent base material may be, for example, one or more selected from the group consisting of glass, polyester (PET), and polyether sulfone (PES), and preferably may be glass. In addition, the transparent conductive material coated on the transparent base material may be one or more selected from the group consisting of InSnO (ITO), InZnO, ZnO, InZnSnO, TiInZnO, NiInZnO, AZO(Al-doped ZnO), BZO(B-doped ZnO), and Ga-doped ZnO (GZO), and, in embodiments, may be ITO.

In embodiments, the substrate may be coated with the transparent conductive material on the transparent base material and then coated with inert metal nanoparticles. The inert metal nanoparticles may be used without limitation as long as they are electrically inactive metal nanoparticles, but preferably may be one or more selected from the group consisting of Pt, Au, Ru, Rh, Pd, Os, and Ir, and, in embodiments, may be Pt. In this case, the method of coating the inert metal nanoparticles is not limited as long as it is a method of coating the inert metal nanoparticles in general, but preferably, a method of immersing a base material coated with a conductive material in an inert metal nanoparticle dispersion solution or a method of spray coating using an inert metal nanoparticle dispersion solution may be used. In this case, when the substrate without coating the inert metal nanoparticles is used, when the voltage is applied, the electrodeposition is poor and it is generated in a coagulated form, so that proper nanoparticles are not formed properly, which may be disadvantageous in lowing the transmittance. In conclusion, when the substrate coated with the inert metal nanoparticles is used, the coagulation of the deposited nanoparticles is minimized compared to the other cases, so that the surface plasmon effect may be very effective in lowing the transmittance of light when the voltage is applied.

According to an embodiment of the present disclosure, the thickness of the conductive material coating on the substrate may be 50 to 350 nm. In this case, when the thickness of the conductive material coating is less than 50 nm, a sheet resistance of the substrate may be somewhat large, and if the thickness of the conductive material coating is greater than 350 nm, deterioration of the transparency of the substrate may occur. In addition, in the case of a transparent base material, the thickness is not limited and may be selected in various ways depending on the purpose, but may have a thickness of, for example, 0.1 to 10,000 mm. In some embodiments, the thickness of the transparent base material is 0.1 mm-10 mm. In other embodiments, the thickness of the transparent base material is 0.1 mm-1 mm.

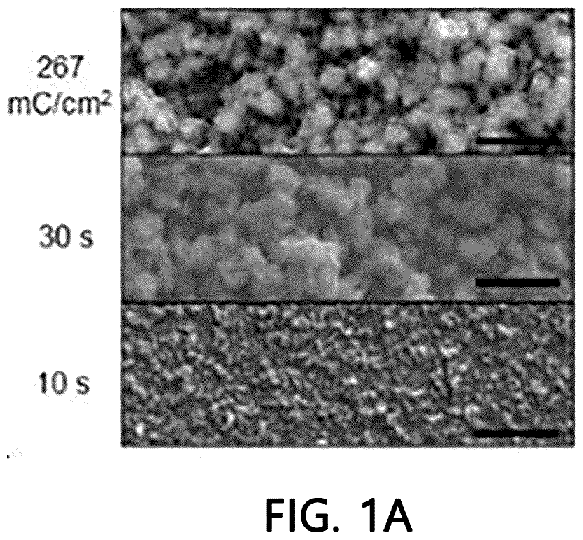

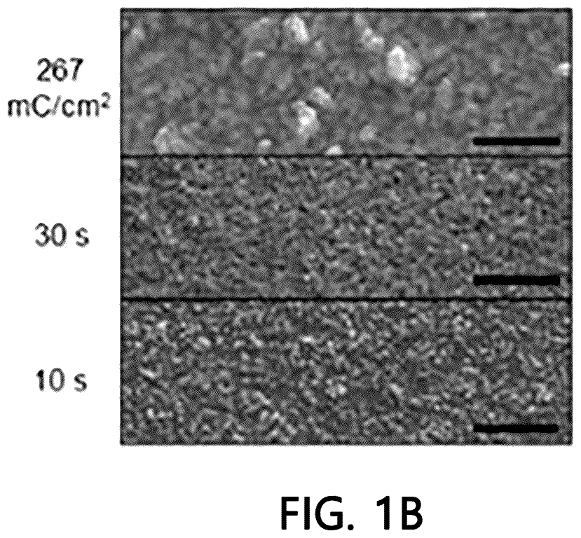

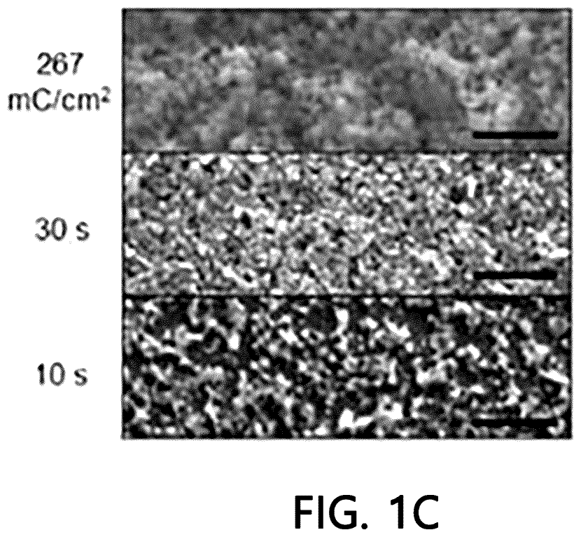

Hereinafter, the nanoparticles to be formed when the voltage is applied will be described in more detail with reference to FIGS. 1A to 1C.

FIGS. 1A to 1C are photographs taken by using a scanning electron microscope (SEM) of a state in which nanoparticles are formed on a substrate by applying voltage to an electrodeposition smart window according to an embodiment of the present disclosure. More specifically, a DMSO solution containing Zn(CH₃COO)₂ of 50 mM, ZnBr₂ of 50 mM, and NaCH₃COO of 67 mM was used as the electrolyte, and Zinc nanoparticles were deposited onto the substrate by applying a voltage of −0.9 V to the counter electrode, with Zn/Zn²⁺ serving as the reduction electrode. In this case, the electrolyte was prepared by mixing the above materials, and then adding ethyl cellulose (mean Mv ˜90,000) at 2.0% w/v to form a gel and stirring for at least 2 hours. In this case, in FIG. 1A a substrate was used in which an electrode of a self-assembled monolayer (SAM) of Pt nanoparticles (hereinafter, referred to as “Pt NPs SAM”) was formed on a tin-doped indium oxide (ITO) glass electrode, in FIG. 1B, a substrate was used in which an electrode of a spray-coated Pt nanoparticles (hereinafter referred to as “spray-coated Pt NPs”) was formed on an ITO glass electrode, and in FIG. 1C, the same electrode as in FIG. 1A was used, but deposition was performed after adding polyvinylpyrrolidone (PVP) to the electrolyte at a concentration of 1 μM. In this case, the PVP was injected after the gel was formed (hereinafter, referred to as “Pt NPs SAM with PVP”). At this time, for each case, as shown in the drawing, a picture is shown after applying a voltage and performing deposition 10 seconds later, 30 seconds later, and at a total charge density of 267 mC/cm².

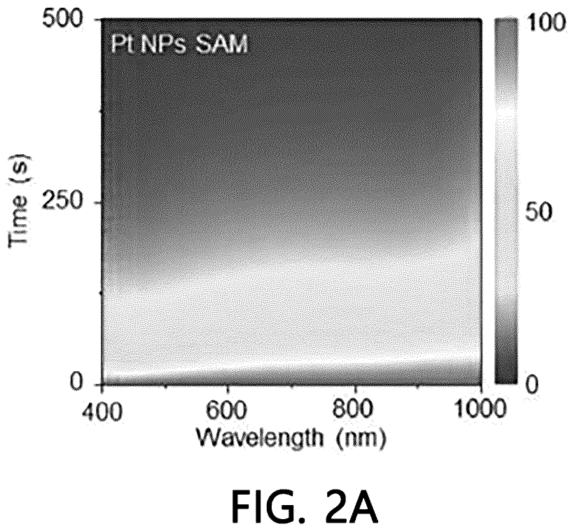

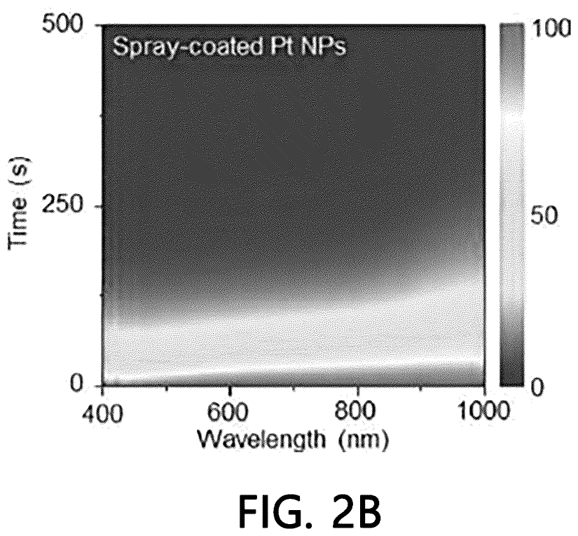

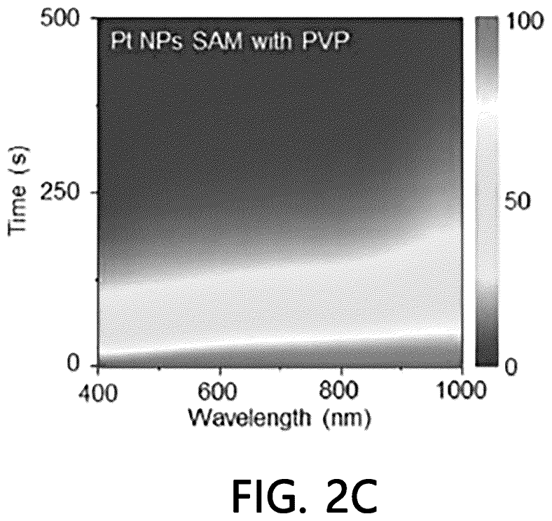

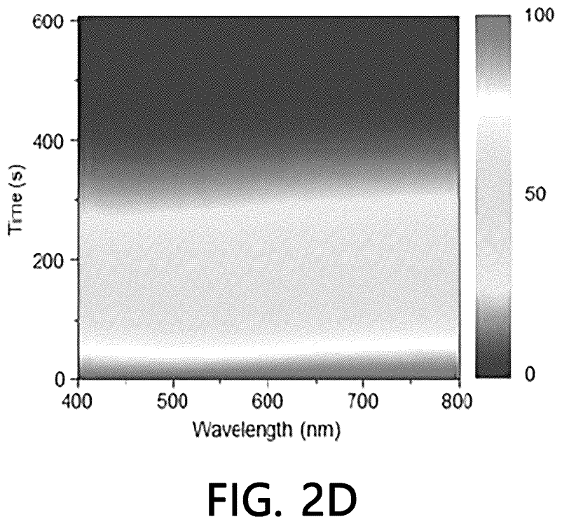

As may be seen from FIGS. 1A to 1C, it may be seen that in all cases, when voltage is applied, zinc was electrodeposited on the substrate in the form of nanoparticles. The thus-deposited zinc nanoparticles exhibit an effect of absorbing the incoming light and lowering the light transmittance. This will be described in more detail with reference to FIGS. 2A to 2C.

FIGS. 2A to 2D each shows a change in transmittance over deposition time for each wavelength in a case where the electrodeposition is performed under the same conditions as those of FIGS. 1A to 1C. In addition, FIG. 2D shows a change in transmittance over deposition time for each wavelength when an indium oxide (ITO) glass electrode doped with tin was used only for the electrode (hereinafter, referred to as “bare ITO”), although the conditions different from FIG. 1A are all the same. The transmittance for each wavelength of light is expressed as a change in color based on the right bar.

As may be seen from FIGS. 2A to 2D, it may be seen that, in all cases, the transmittance gradually decreases across the entire wavelength band as the deposition time increases, and the transmittance for the entire wavelength band approaches nearly 0% after a sufficient time has passed. Through this, it may be seen that when the nanoparticles are formed using electrodeposition, the transmittance may be controlled by adjusting the time for applying voltage, and when voltage is applied for a sufficient time, the light transmission may be completely blocked, thereby implementing excellent black.

In addition, when comparing the degree to which the transmittance decreases as the voltage time increases by wavelength, it may be seen that the transmittance decrease almost parallel to the x-axis is trend. This means that as voltage is applied, the transmittance decreases at a similar rate in the corresponding wavelength range. As described above, when the transmittance decreases at a constant rate across the entire wavelength band, since only the transmittance for a specific wavelength is abnormally high is excluded, there is no need to apply more voltage in order to decrease the transmittance of the specific wavelength band, thereby implementing black more efficiently. Therefore, in implementing black, it is very excellent in terms of energy efficiency.

More specifically, it may be seen that the case of FIG. 2D using bare ITO as an electrode takes more time to decrease the transmittance as compared to FIGS. 2A to 2C using a platinum-coated electrode, and therefore it may be seen that the light-blocking ability of the nanoparticles deposited on the corresponding electrode is higher when using the platinum-coated electrode than when not.

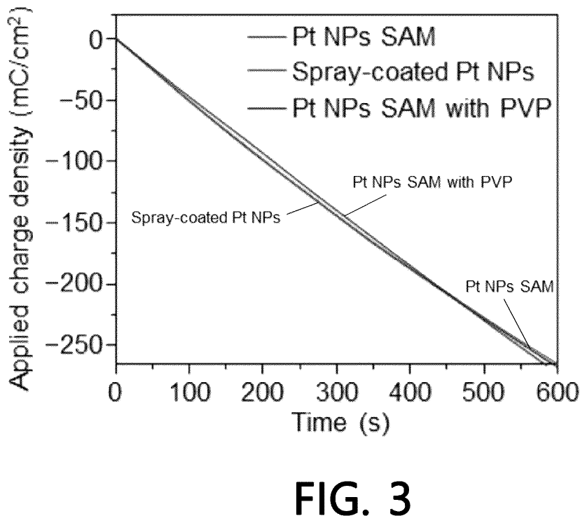

More specifically, FIGS. 3, 4, 5, and 6 will be described.

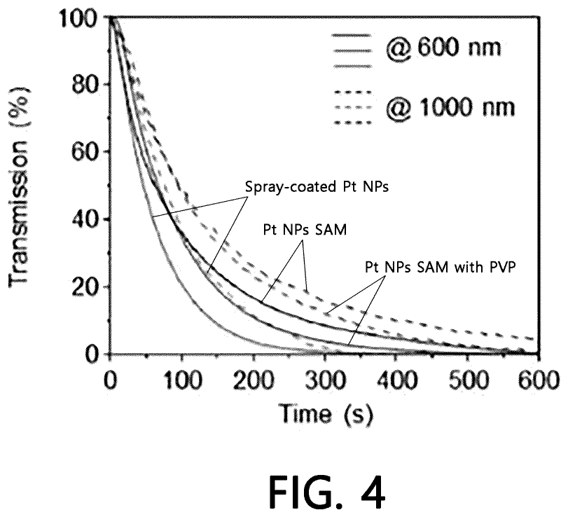

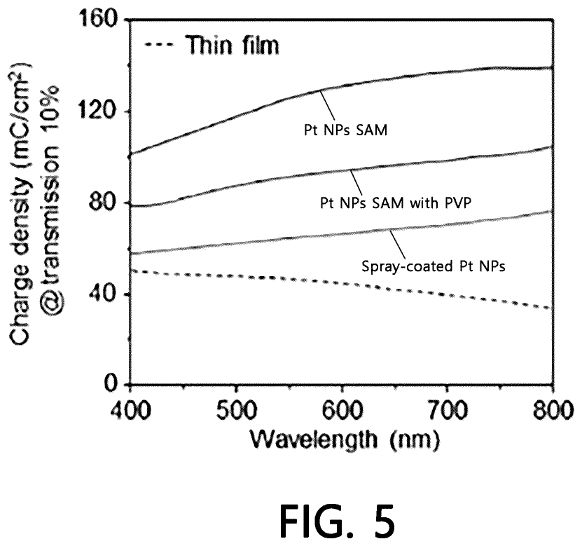

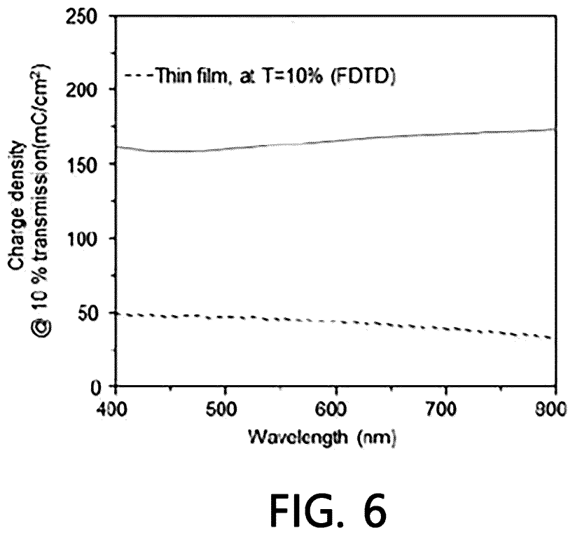

FIG. 3 shows a current density applied over time in the electrodeposition experiments of FIGS. 1A to 1C. FIG. 4 shows the transmittance over time with respect to light having wavelengths of 600 nm and 1000 nm for each electrode in the electrodeposition experiments of FIGS. 1A to 1C, and the electrodes corresponding to the respective graphs are the same as those shown in FIG. 3. FIG. 5 shows a current density value applied until the transmittance reaches 10% for light of each wavelength band in the electrodeposition experiments of FIGS. 1A to 1C. FIG. 6 shows a current density value applied until the transmittance reaches 10% for light of each wavelength band in the electrodeposition experiments of FIG. 2D using bare ITO as an electrode. In FIGS. 5 and 6, data in the case of assuming that an ideally completely implemented zinc film was deposited through FDTD simulation is shown as dotted lines.

As may be seen from FIG. 4, it may be seen that, in all cases, the transmittance decreases continuously as the electrodeposition time increases, and finally, the transmittance is very close to 0%. Accordingly, it may be seen that the transmittance may be easily controlled by adjusting the amount of electrodeposition of the metal nanoparticles by adjusting the application time or direction of the voltage, and when sufficient time is given for the electrodeposition, excellent black may be implemented.

In addition, referring to FIGS. 5 and 6, it may be seen that in all cases, the charge density applied until the transmittance reaches 10% is similar to that of the ideal zinc film. In addition, it may be seen that the graph is maintained almost parallel to the x-axis, which means that the degree of decrease in transmittance when applying voltage does not have a significant difference across all wavelength bands, that is, black may be effectively implemented even with a small amount of current applied. Furthermore, comparing FIGS. 5 and 6, it may be seen that the charge density required to reach 10% of transmittance is greater when bare ITO is used as an electrode than when it is not. Through this, it may be confirmed that the light blocking ability of the metal nanoparticles deposited when voltage is applied is superior when the platinum-coated electrode is used as a substrate than when it is not.

In addition, referring to FIG. 5, it may be seen that a case in which PVP is included in the electrolyte reaches 10% of transmittance with the lowest charge density, because when PVP is present in the electrolyte, it improves the electrodeposition uniformity of the metal nanoparticles, thereby improving the light blocking ability of the electrodeposited metal nanoparticles.

According to an embodiment of the present disclosure, the average radius of the nanoparticles may be 20 to 120 nm. More specifically, the average distance between the particles means the average value of the distance between the centers of each particle, and in this case, the average radius of the nanoparticles may be measured through data statistical processing through experimental observation using an electron microscope and an AFM, and the average distance between the nanoparticles may also be measured through data statistical processing through experimental observation using the electron microscope and the AFM.

More specifically, when the nanoparticles are deposited, a surface plasmon resonance phenomenon is generated at an edge portion of the nanoparticles adjacent to the substrate, thereby providing the ability to absorb light. In addition, since the plasmon resonance phenomenon is generated between the adjacent nanoparticles, it is important factor in adjusting the distance between the nanoparticles in inducing the plasmon resonance phenomenon. When the plasmon resonance phenomenon is generated, the absorbance of light increases due to the phenomenon, thereby effectively lowering the transmittance of light.

More specifically, the average distance between the nanoparticles may be greater than twice and less than or equal to four times the average radius of the nanoparticles.

In this case, if the average distance between the nanoparticles is greater than four times the average radius of the nanoparticles, the distance between the nanoparticles becomes too far away from the size of the nanoparticles, and thus the interaction of near waves due to the plasmon resonance phenomenon between adjacent nanoparticles is not possible, thereby deteriorating the effect of increasing the absorbance.

In addition, if the average distance between the nanoparticles is less than or equal to twice the average radius of the nanoparticles (if there is a nanoparticle agglomeration), a shape similar to the metal film is formed, and thus the plasmon resonance phenomenon generated at the edge portion of the nanoparticles is not smoothly excited, thereby inhibiting the effect of increasing the absorbance.

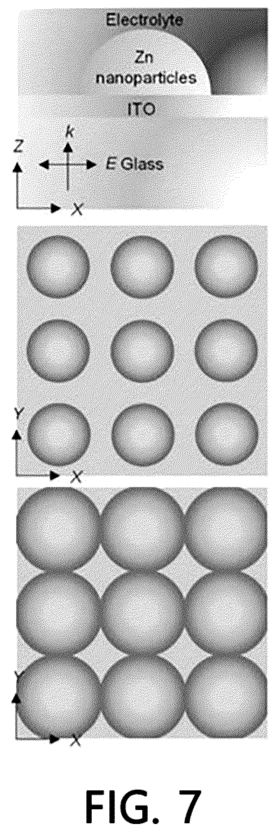

More specifically, it will be described with reference to FIGS. 7, 8, and 9.

FIG. 7 shows an example in which hemispherical Zn nanoparticles are arranged on a virtual substrate of 400 nm×400 nm in performing FDTD simulation.

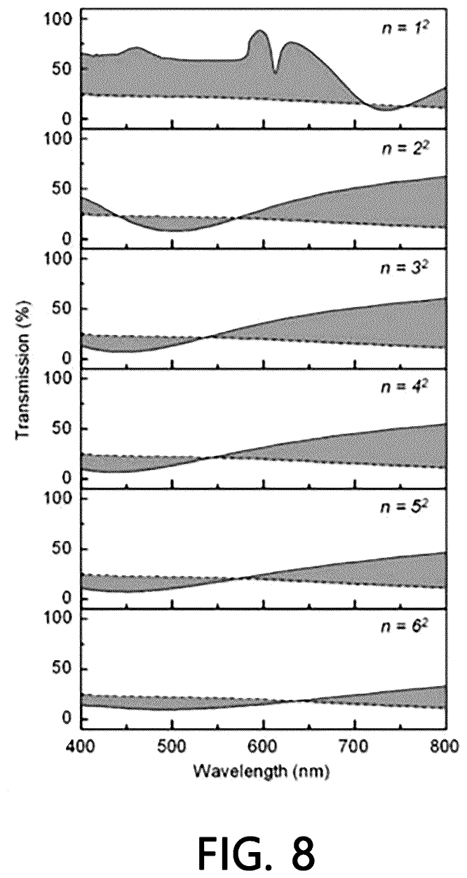

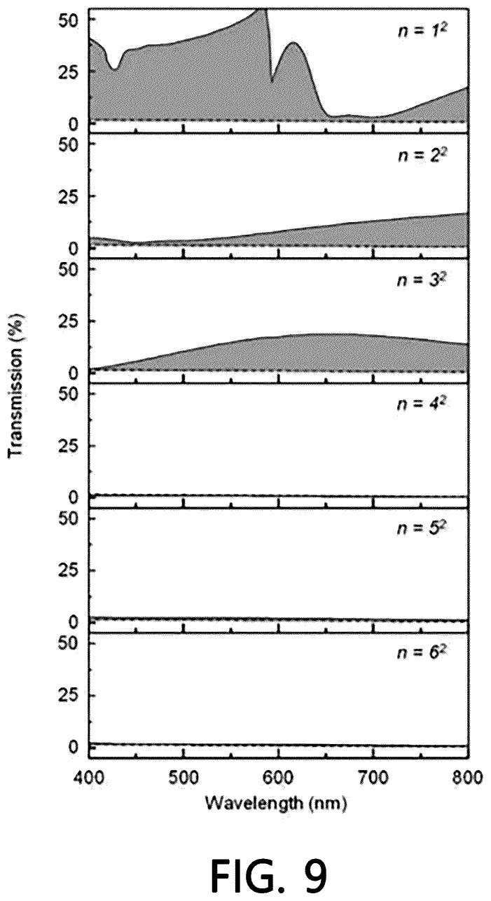

The FDTD simulation is performed to compare absorbance between a uniform Zn thin film and Zn nanoparticles. Therefore, after it is assumed that Zn having the same amount as a uniform Zn thin film having a thickness of 15 nm and 40 nm was formed on the substrate, assuming that the corresponding nanoparticles are uniformly arranged from 12 to 62, the transmission of incident light by wavelength is compared with the uniform thin film for each case. As shown in the top drawing of FIG. 7, a hemispherical Zn nanoparticle is formed on the substrate, and in the middle and bottom drawings of FIG. 7, Zn having the same amount as Zn thin films having a thickness of 15 nm and 40 nm was arranged as 32 nanoparticles, respectively. In addition, FIG. 8 shows the transmittance (solid lines) compared to the transmittance (dotted lines) of a 15 nm-thick Zn thin film when the same amount of Zn as in the 15 nm-thick Zn thin film is uniformly arranged in the form of 12 to 62 nanoparticles, and FIG. 9 shows the transmittance (solid lines) compared to the transmittance (dotted lines) of a 40 nm-thick Zn thin film when the same amount of Zn as in the 40 nm-thick Zn thin film is uniformly arranged in the form of 12 to 62 nanoparticles.

In addition, Table 1 shows the radius of the particles and the distance between the particles in each case.

TABLE 1

| | the same amount of Zn as | | the same amount of Zn as | |
|---|---|---|---|---|
| | in 15 nm-thick thin film | | in 40 nm-thick thin film | |
| | | average | | average |
| | average | distance | average | distance |
| | radius of | between | radius of | between |
| nano- | nano- | nano- | nano- | nano- |
| particle | particles | particles | particles | particles |
| number | (nm) | (nm) | (nm) | (nm) |
| 1² | 105 | 400 | 145 | 400 |
| 2² | 66 | 200 | 91 | 200 |
| 3² | 51 | 133 | 70 | 133 |
| 4² | 42 | 100 | 58 | 100 |
| 5² | 36 | 80 | 59 | 80 |
| 6² | 32 | 67 | 44 | 67 |

As may be seen from FIGS. 8 and 9, and Table 1, when the distance between the nanoparticles may be greater than twice and less than or equal to four times the radius of the nanoparticles, the distance between the nanoparticles is formed at an appropriately close level, and it may be confirmed that there is an advantage in terms of absorbance compared to a nano-thin film made of the same amount of zinc. On the other hand, when the distance between nanoparticles is less than or equal to twice the radius of the nanoparticles, the particles are located too close to each other, and thus the surface plasmon effect is hardly generated, so that the absorbance is formed at the same level as that of the thin film.

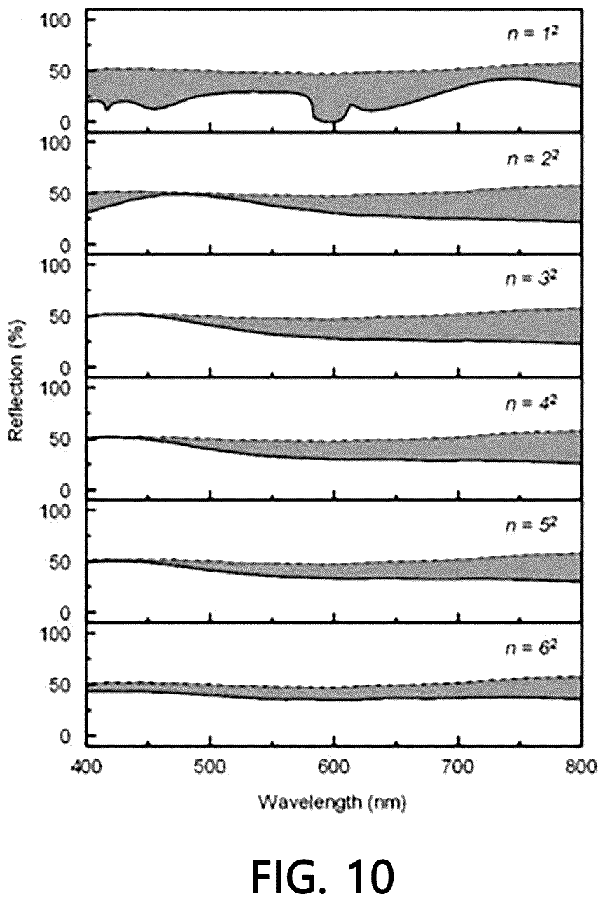

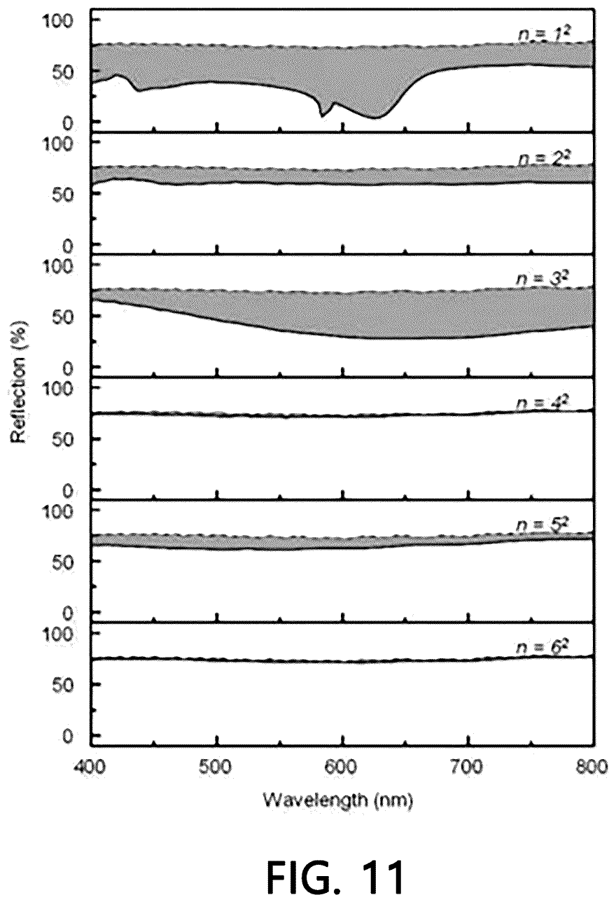

The generation of the surface plasmon effect is described in more detail with reference to FIGS. 10 and 11.

In FIGS. 10 and 11, in performing the FDTD simulation as shown in FIG. 7, FIG. 10 shows the reflectance of nanoparticles having the same amount of Zn as in a 15 nm-thick Zn thin film, and FIG. 11 shows the reflectance of nanoparticles having the same amount of Zn as in a 40 nm-thick Zn thin film.

As may be seen from FIGS. 10 and 11, it may be seen that the reflectance of the nanoparticles is lower than that of a uniform thin film, because some of the reflected energy is converted to form surface plasmon resonance. Accordingly, through this, it may be confirmed that the surface plasmon effect is generated in the case of nanoparticles, and the absorbance thereof increases.

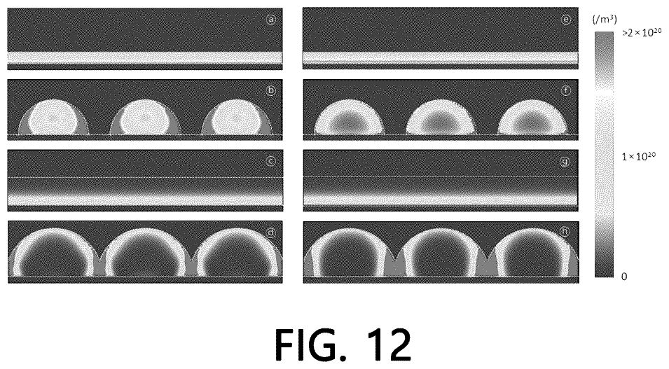

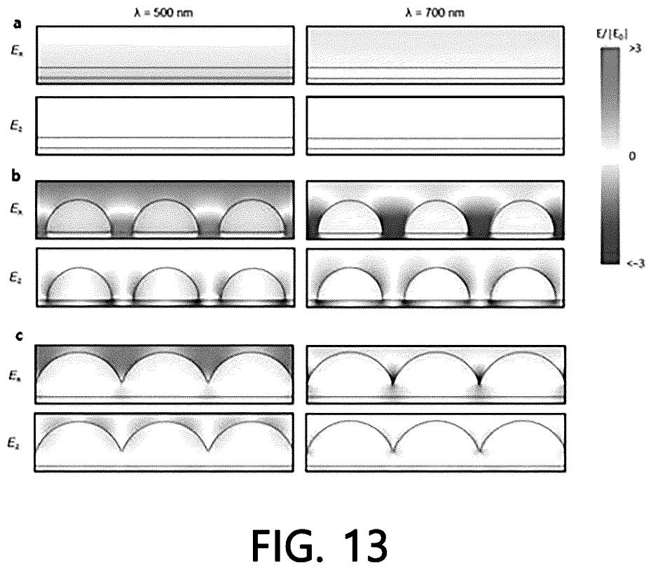

In addition, the generation of the surface plasmon effect is described in more detail with reference to FIGS. 12 and 13.

FIG. 12 is a drawing showing a volume absorption mapping of light in performing the FDTD simulation as shown in FIG. 7. At this time, (a) to (d) represent a volume absorption mapping of 500 nm light, and (e) to (h) represent a volume absorption mapping of 700 nm light. In addition, (a) and (e) represent a uniform 15 nm-thick thin film, and (c) and (g) represent a uniform 40 nm-thick thin film. (b) and (f) show the case where the same amount of Zn as in the 15 nm-thick Zn thin film in the simulation of FIG. 7 is arranged in the form of 32 nanoparticles, and (d) to (h) show the case where the same amount of Zn as in the 40 nm-thick Zn thin film in the simulation of FIG. 7 is arranged in the form of 32 nanoparticles.

As may be seen from FIG. 12, it may be seen that the amount of light absorption is amplified by the surface plasmon phenomenon at the edge of each nanoparticle for light having wavelengths of 500 nm and 700 nm. By such a plasmon phenomenon, it may be advantageous in terms of absorbance compared to a uniform thin film made of the same amount of zinc.

In addition, FIG. 13 also shows the results of performing an electric field profile analysis in the case of the FDTD simulation of FIG. 12. Part a of FIG. 13 shows the case of a uniform thin film, and it may be seen that since the surface plasmon phenomenon is not generated in this case, only an electric field parallel to the incident electric field Ex is present, and an Ez component does not exist. On the other hand, in the case of part b of FIG. 13, which is an electric field profile for the array of 32 nanoparticles made of the same amount of Zn as in the 15 nm-thick Zn thin film, it may be observed that an electric field of the Ez component is generated at the edge of each nanoparticle. When the spacing between the nanoparticles satisfies a predetermined level, the surface plasmon resonance phenomenon is generated between the nanoparticles, so that the electric field of the Ez component is observed. The light absorbance of nanoparticles increases due to this surface plasmon phenomenon. In addition, in the case of part e of FIG. 13, which is an electric field profile for an array of 32 nanoparticles made of the same amount of Zn as in the 40 nm-thick Zn thin film, it may be confirmed that the intensity of the Ez component is weaker compared to the (b) where the nanoparticles are brought into contact with each other and the particles are spaced apart from each other by a predetermined distance. In conclusion, in the case where the average radius of the nanoparticles is 51 nm and the average distance between the nanoparticles is 133 nm, the average distance between the nanoparticles is appropriately secured to be more than twice and less than four times the average radius of the nanoparticles, thereby maximizing the generation of surface plasmon phenomenon, thereby increasing the absorbance of the nanoparticles. In this case, the increase in the absorbance of the nanoparticle array is that excellent absorbance may be achieved even by depositing as much small nanoparticles, which means that the absorbance of the smart window may be widely adjusted with a small amount of electric energy, which ultimately means that the electrical efficiency is very excellent.

According to an embodiment of the present disclosure, the nanoparticles may further include one or more selected from the group consisting of oxides of Zn, Ag, Cu, Bi, and Pb. For example, in the case of zinc, when voltage is applied, ZnO may be formed during a process in which Zn ions are deposited on the substrate. The resulting nanoparticles may also include ZnO together with Zn. In this case, the main component of the nanoparticles may be Zn, Ag, Cu, Pb, and Bi, but not the oxide, and preferably, the ratio of the oxide in the nanoparticles may be 0 to 50 volume %.

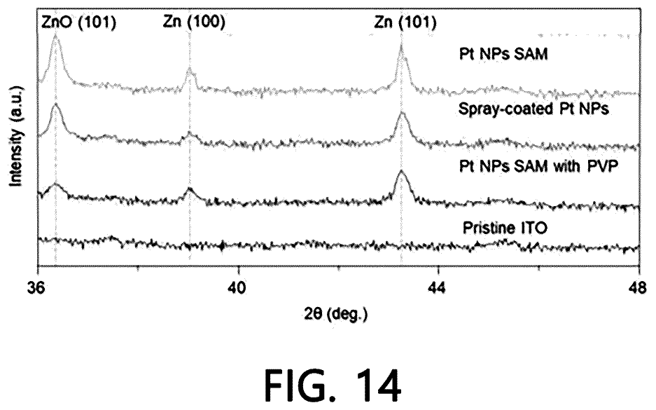

More specifically, it will be described with reference to FIG. 14.

FIG. 14 shows the results of performing the X-ray diffraction test on each deposited nanoparticle after depositing the nanoparticles on each substrate at a charge density of 267 mC/cm², as in the case of FIGS. 1A-1C. As may be seen from FIG. 14, it may be confirmed that Zn and ZnO are simultaneously present in all cases.

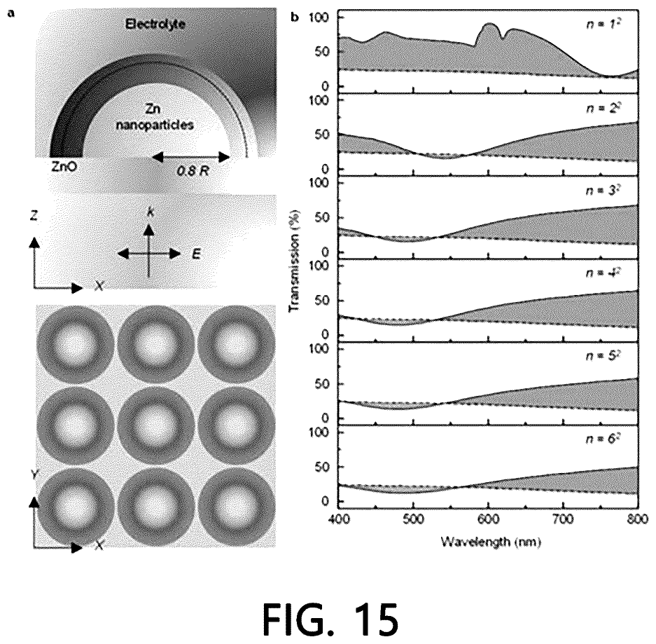

In addition, more specifically, it will be described with reference to FIG. 15.

FIG. 15 shows a measurement of the transmittance of the nanoparticle array having the same amount of Zn as in a 15 nm-thick Zn thin film in the FDTD simulation when 20% of the outer radius of each nanoparticle is replaced with ZnO. The solid lines represent the transmittance of the nanoparticle, and the dotted lines represent the transmittance of a uniform 15 nm-thick Zn thin film. As may be seen from FIG. 15, it may be confirmed that even when 20% of the outer radius is replaced with ZnO, there is a section having a lower transmittance compared to the uniform thin film, indicating that the surface plasmon effect is generated even when ZnO is partially included in the nanoparticles, which is superior to the nano thin film in terms of absorbance.

According to an embodiment of the present disclosure, the electrodeposition smart window according to the present disclosure may include a dendrite formed inside or on the nanoparticle layer. More specifically, when voltage is applied to the smart window according to the present disclosure, the nanoparticle layer may be formed and simultaneously the dendrite may be formed inside or on the nanoparticle layer. In this case, the dendrite performs dynamics that generate the surface plasmon resonance effect like the nanoparticle. The surface plasmon effect is generated by the dendrite structure, so that the absorbance of incident light is maximized, and thus the absorbance may be controlled widely with a small amount of electric energy, and simultaneously excellent black may be realized, which is very superior to a comparative smart window.

More specifically, when the dendrite is formed inside the nanoparticle layer, the dendrite may be greater than 0 volume % and less than or equal to 50 volume % in the corresponding layer. In addition, when the dendrite forms a separate dendrite layer on the nanoparticle layer, the thickness of the corresponding dendrite layer may be greater than 0 nm and less than or equal to 100 nm, and the dendrite may occupy 0 to 50 volume % in the corresponding dendrite layer.

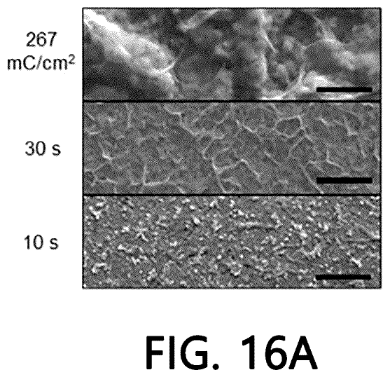

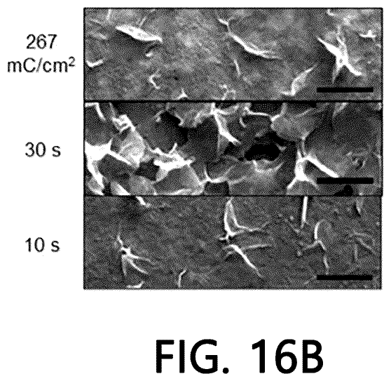

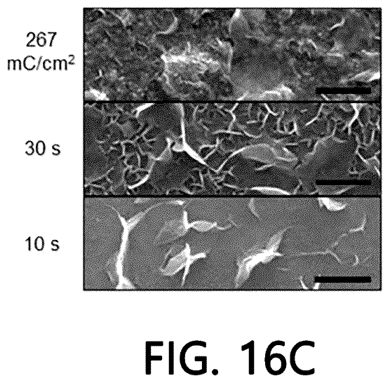

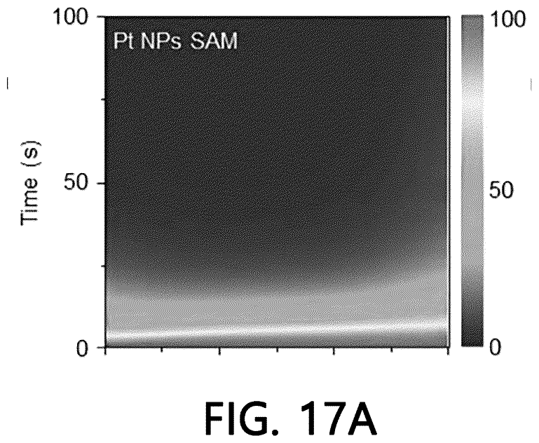

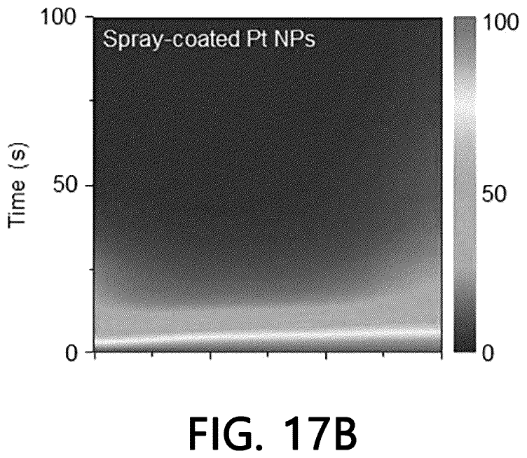

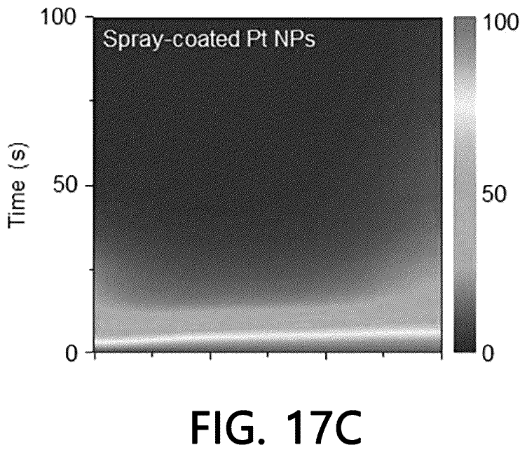

More specifically, it will be described with reference to FIGS. 16A to 16C and FIGS. 17A to 17C.

FIGS. 16A to 16C are photographs taken by using a scanning electron microscope (SEM) of a state in which nanoparticles are formed on a substrate by applying voltage to an electrodeposition smart window according to an embodiment of the present disclosure. More specifically, a DMSO solution containing Zn(CH₃COO)₂ of 300 mM, ZnBr₂ of 300 mM, and NaCH₃COO of 400 mM was used as an electrolyte, and Zinc nanoparticles were deposited onto the substrate by using Zn/Zn²⁺ serving as the reducing electrode and applying a voltage of −0.9 V to the counter electrode. In this case, the electrolyte was prepared by mixing the above materials and then adding ethyl cellulose (average Mv ˜90,000) at 2.0% w/v to form a gel and stirring for at least 2 hours. In this case, FIG. 16A used Pt NPs SAM as the substrate, FIG. 16B used spray-coated Pt NPs as the substrate, and FIG. 16C used the same electrode as in FIG. 16A, but after including polyvinylpyrrolidone (PVP) to be 1 μM in the electrolyte, deposition was performed. In this case, PVP was added after forming the gel (hereinafter referred to as “Pt NPs SAM with PVP”). At this time, for each case, as shown in the drawing, a picture is shown after applying a voltage and performing deposition 10 seconds later, 30 seconds later, and at a total charge density of 267 mC/cm².

As may be seen from FIGS. 16A to 16C, it may be seen that in all cases, when voltage is applied, a dendrite structure is formed inside or on the nanoparticle layer. Such a dendrite structure exhibits an effect of absorbing incident light by its surface plasmon effect, thereby lowering the transmittance of light. More specifically, this will be described with reference to FIGS. 17A to 17C.

FIGS. 17A to 17C show a change in transmittance over deposition time for each wavelength when the electrodeposition is performed under the same conditions as FIGS. 16A, 16B, and 16C, respectively.

As may be seen from FIGS. 17A to 17C, it may be seen that, in all cases, the transmittance gradually decreases across the entire wavelength band as the deposition time increases, and the transmittance for the entire wavelength band approaches nearly 0% after a sufficient time has passed. Through this, it may be seen that when the dendrite structure is formed inside or on nanoparticle using the electrodeposition, the transmittance may be controlled by adjusting the time for applying voltage, and when voltage is applied for a sufficient time, the light transmission may be completely blocked, thereby implementing excellent black.

In addition, when comparing the degree to which the transmittance decreases as the voltage time increases by wavelength, a decreasing trend of transmittance almost parallel to the x-axis may be confirmed. This means that as voltage is applied, the transmittance decreases at a similar rate in the corresponding wavelength range. As described above, when the transmittance decreases at a constant rate across the entire wavelength band, since only the transmittance for a specific wavelength is abnormally high is excluded, there is no need to apply more voltage in order to decrease the transmittance of the specific wavelength band, thereby implementing black more efficiently. Therefore, in implementing black, it is excellent in terms of energy efficiency.

In particular, when FIGS. 17A to 17C are compared with FIGS. 2A to 2C, it may be seen that the transmittance over the entire wavelength band decreases at a much faster rate than that of FIGS. 2A to 2C, and also decreases while maintaining a transmittance graph very parallel to the x-axis. This indicates that the incident light can be absorbed very efficiently because the nanoparticle structure and the dendrite structure is observed simultaneously, compared to the case where only the nanoparticle structure is observed. In conclusion, the formation of dendrites means that the absorbance may be controlled over a wider range even with less electrical energy, and better black may be implemented more efficiently.

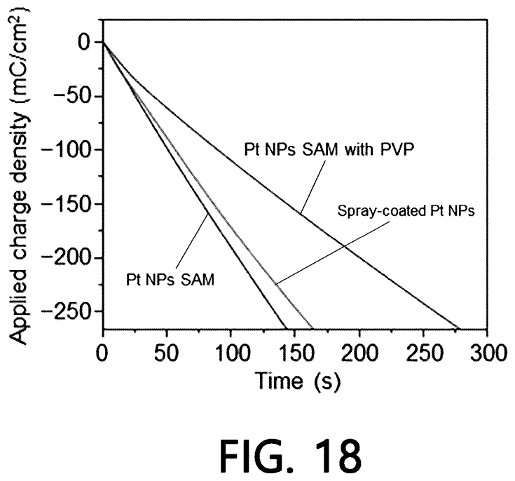

In addition, more specifically, it will be described with reference to FIGS. 18, 19, and 20.

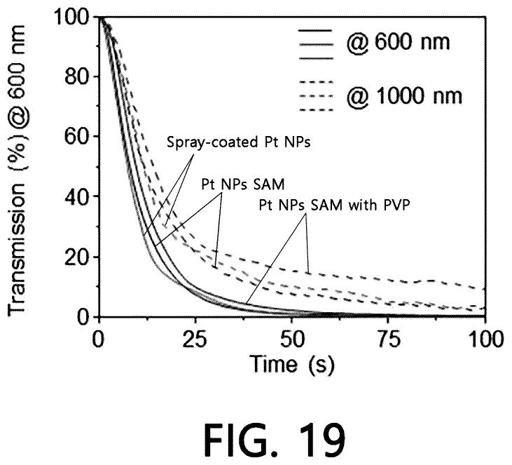

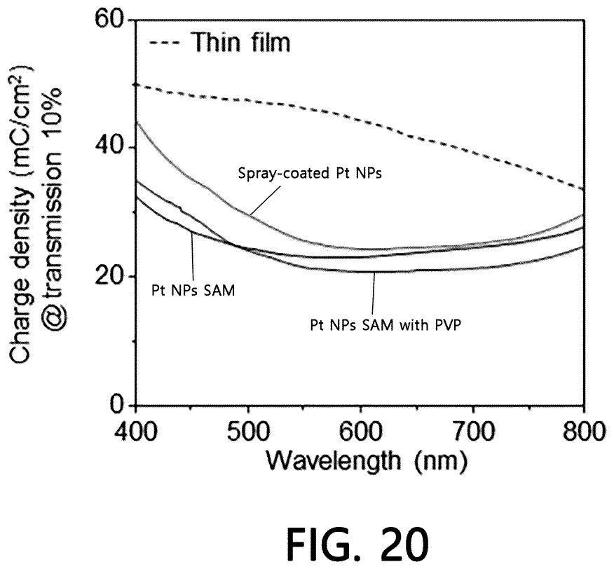

FIG. 18 represents a current density applied over time in the electrodeposition experiment of FIGS. 16A to 16C. FIG. 19 shows the transmittance over time with respect to light having wavelengths of 600 nm and 1000 nm for each electrode in the electrodeposition experiments of FIGS. 16A to 16C, and the electrodes corresponding to the respective graphs are the same as those shown in FIG. 18. FIG. 20 shows a current density value applied until the transmittance reaches 10% for light of each wavelength band in the electrodeposition experiments of FIGS. 16A to 16C. In FIG. 20, data in the case of assuming that an ideally completely implemented zinc film was deposited through FDTD simulation is shown as dotted lines.

As may be seen from FIG. 19, it may be seen that, in all cases, the transmittance decreases continuously as the electrodeposition time increases, and finally, the transmittance is very close to 0%. Accordingly, it may be seen that the transmittance may be easily controlled by adjusting the amount of electrodeposition of the metal nanoparticles and the dendrites by adjusting the application time or direction of the voltage, and when sufficient time is given for the electrodeposition, excellent black may be implemented.

In addition, referring to FIG. 20, it may be seen that in all cases, the charge density applied until the transmittance reaches 10% is all lower than that of the ideal zinc film (thin film). As described above, in the case of the electrodeposition smart window according to the embodiment of the present disclosure, when both the nanoparticles and the dendrites are formed, the current density applied until the transmittance reaches 10% at the wavelength range of 400 to 800 nm may be always lower than that of the case of the metal thin film including the same amount of zinc.

In addition, it may be seen that the graph is maintained almost parallel to the x-axis, which means that the degree of decrease in transmittance when applying voltage does not have a significant difference across all wavelength bands, that is, black may be effectively implemented even with a small amount of current applied. Furthermore, referring to FIG. 20, it may be seen that a case in which PVP is included in the electrolyte reaches 10% of transmittance with the generally lowest charge density, because when PVP is observed in the electrolyte, it improves the electrodeposition uniformity of the metal nanoparticles, thereby improving the light blocking ability of the electrodeposited metal nanoparticles.

In this case, the dendrite may be one or more selected from the group consisting of Zn, Ag, Cu, Bi, Pb and oxides of Zn, Ag, Cu, Bi, and Pb. More specifically, the dendrite may include one or more selected from the group consisting of the same metal as the deposited nanoparticles and the oxide thereof. In this case, preferably, the dendrite may include one or more selected from the group consisting of Zn and ZnO, and, in embodiments, ZnO may be used as a main component.

In this case, the dendrite structure may be formed by, for example, ZnO as a main component, and this may be configured in such a manner that Zn formed at the time of application of the voltage to the smart window according to the embodiment of the present disclosure reacts with O2 or H2O to form ZnO, and ZnO thus formed forms a dendrite structure. In this case, when the main component of the dendrite is ZnO, the transmittance for light may be greatly reduced or increased even by the use of a small electrical energy due to the plasmon resonance phenomenon caused by the peripheral area and the metal-dielectric-metal structure, so that an electrically very efficient electrodeposition smart window may be implemented.

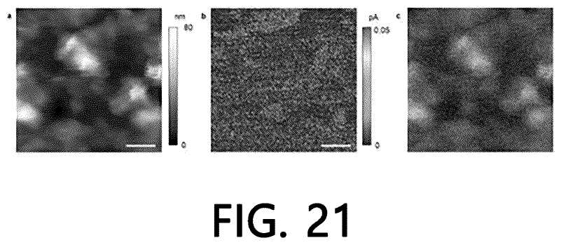

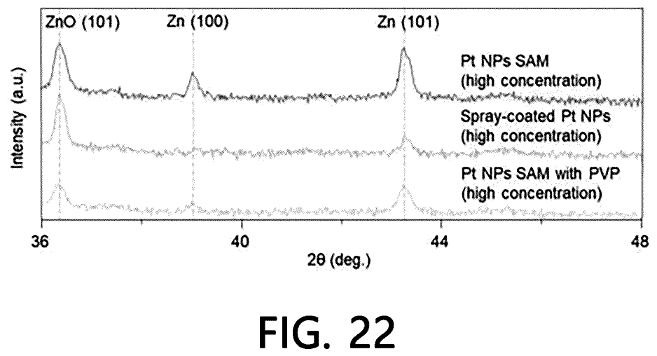

More specifically, it will be described with reference to FIGS. 21 and 22.

FIG. 21 shows the results of conductive-atomic force microscopy (c-AFM) when the electrodeposition is performed with a Pt NPs SAM electrode for 30 seconds in FIGS. 16A-16C. Part a of FIG. 21 shows a mapping of a surface height, (b) shows a mapping of a surface current using an external bias of 9V, and (c) shows an overlap of (a) and (b). As may be seen from FIG. 22, the dendrite area is spatially distributed in a high area of ˜40 nm, and a portion where the dendrite is observed exhibits more insulating characteristics than other areas. Through this, it may be seen that the dendrite is composed of ZnO as a main component.

FIG. 22 shows the results of performing the X-ray diffraction test on each deposited nanoparticle after depositing the nanoparticles on each substrate at a charge density of 267 mC/cm², as in the case of FIGS. 16A-16C. As may be seen from FIG. 22, it may be seen that ZnO is observed in all cases. Accordingly, the dendrite in each case may include ZnO. Preferably, the dendrite may be made of ZnO as a main component.

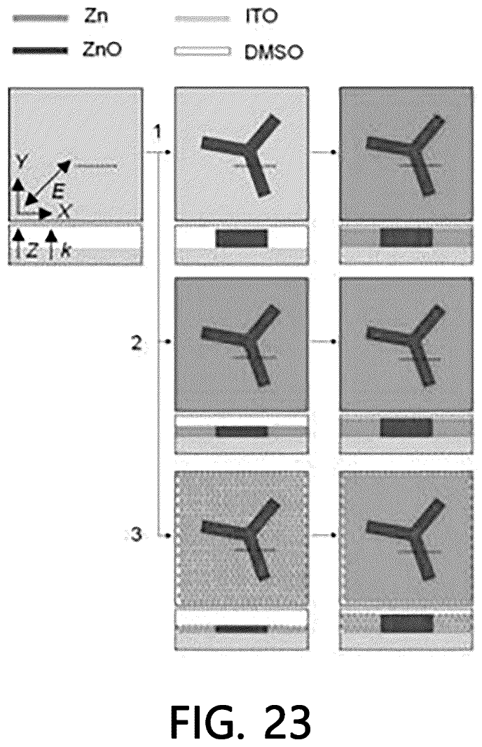

More specifically, the electrodeposition structure including the dendrite having a main component consisting of ZnO and the nanoparticle having a main component comprising or consisting of Zn will be described with reference to FIGS. 23 to 25.

FIG. 23 is a schematic diagram of a growth model of scenarios 1 to 3 in performing FDTD simulation. In scenario 1, dendrites composed of ZnO is preferentially formed, and a Zn thin film is grown around the dendrites, and in scenario 2. ZnO dendrites and a Zn thin film around them are grown simultaneously, and in scenario 3, dendrites and Zn nanoparticles around them are grown simultaneously. At this time, the substrate is an ITO substrate, and the simulation was performed assuming that a 45-degree polarized wave is reflected from the ITO side toward the electrodeposition material. In addition, the simulation was performed assuming that the final charge density is the same as when a 40 nm thick thin film is formed on a substrate having the same area.

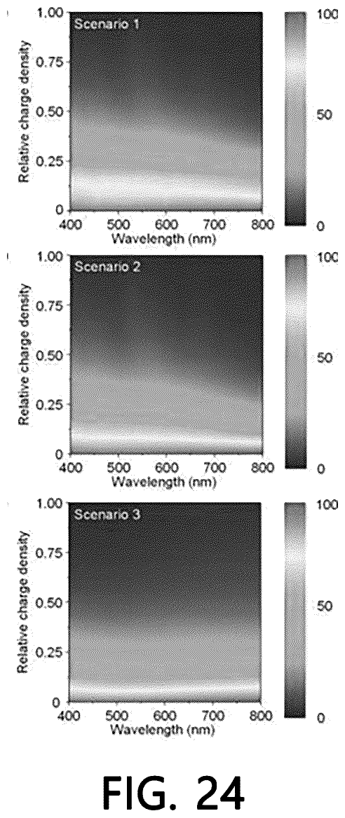

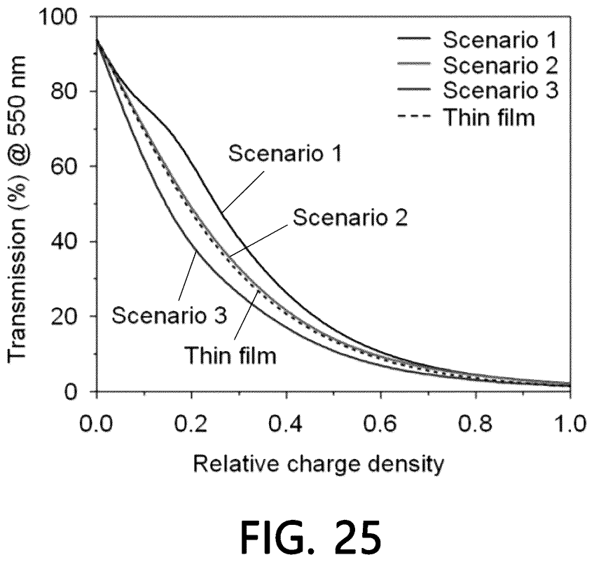

At this time, in performing the simulation of each scenario, FIG. 24 shows the transmittance by wavelength according to the relative charge density (charge density corresponding to the electrodeposition configuration/charge density of the 40 nm thin film) for each scenario, and FIG. 25 shows a reduction in transmittance according to a relative charge density with respect to 550 nm compared to a case of a uniform thin film.

As may be seen from FIGS. 23 to 25, it may be seen that the transmittance of light decreases rapidly even at a lower relative charge density in the scenario 3 in which the nanoparticles and the dendrites are grown simultaneously compared to scenarios 1 and 2, where they do not. In addition, when FIG. 24 is compared with FIGS. 17A to 17C described above, it may be confirmed that the transmittance of light with a relatively low wavelength decreases faster than that of light with a high wavelength in the case of FIGS. 17A to 17C, which are the results for actual electrodepositions, and in the case of scenarios 1 and 2 in FIG. 24, it may be confirmed that the transmittance of light with a high wavelength decreases faster than that of light with a low wavelength. In this case, it may be confirmed that only in the scenario 3, the transmittance of light with a low wavelength decreases faster than that of light with a high wavelength, showing the same tendency as the results of the actual electrodeposition experiment. Further, referring to FIG. 25, it may be seen that in the scenario 1 and the scenario 2, transmittance is similar to or higher than that of a uniform thin film, while in the scenario 3, the transmittance is lower than that of a uniform thin film, which is also consistent with the result of the actual electrodeposition. Further, it may be seen that in the scenario 3, the transmittance is almost uniformly decreased across the entire wavelengths, which means that the transmittance may be reduced with excellent electrical efficiency, and that the transmittance may be uniformly decreased for each wavelength band, thus achieving excellent black.

In conclusion, it may be confirmed through simulation that the actual electrodeposition material has a structure in which nanoparticles and dendrites are simultaneously formed and coexist, and in this case, it may be said that it is excellent in terms of electrical efficiency, such as greatly reducing or increasing the transmittance with a small amount of electrical energy, and at the same time, excellent black may be achieved, and thus it may be seen that it is very excellent in terms of its utilization in that it is very suitable for efficiently operating energy by blocking light, which is one of the main purposes of a smart window.

In embodiments, the dendrite may have a porous structure.

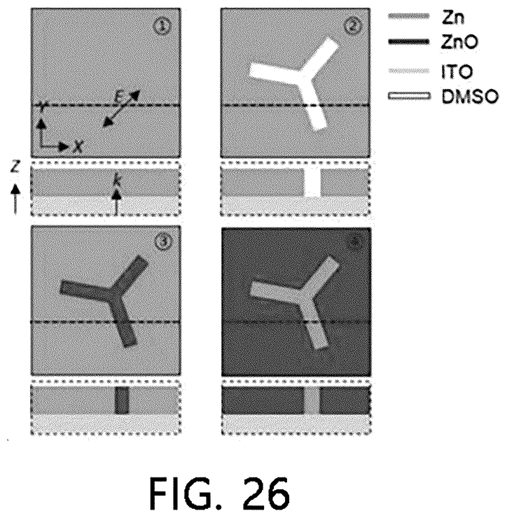

In the case where the dendrite has a porous structure, surface plasmon resonance is generated around the porous structure of the dendrite, and as the absorption efficiency for incident light increases, the transmittance may be greatly adjusted with less electrical energy, thus achieving excellent electrical efficiency. More specifically, it will be described with reference to FIGS. 26 to 28.

FIG. 26 shows a structure for each case and a configuration thereof for FDTD simulation of a dendrite structure. In case 1, a Zn thin film having a uniform thickness of 20 nm is shown, in case 2, a Zn thin film having a dendrite-shaped empty space is shown, in case 3, a Zn thin film having a dendrite structure filled with ZnO inside is shown, and in case 4, a ZnO thin film having a dendrite structure filled with Zn inside is shown. In this case, it is assumed that the cases 2 to 4 are configured to have the same amount of Zn as in the 15 nm-thick Zn thin film, and thus the cases 2 is formed to be 22 nm, case 3 is formed to be 23 nm, and case 4 is formed to be 30 nm, respectively. In addition, the substrate is an ITO substrate, and the simulation was performed assuming that a 45-degree polarized wave is reflected from the ITO side toward the electrodeposition material. In addition, the simulation was performed assuming that the final charge density is the same as when a 40 nm thick thin film is formed on a substrate having the same area.

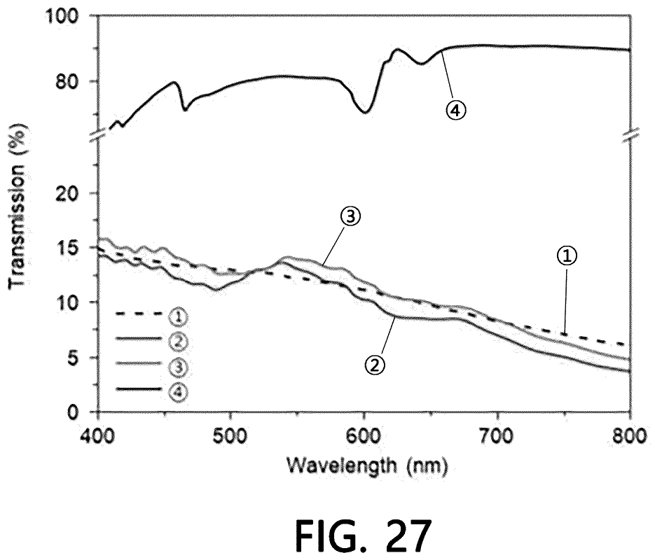

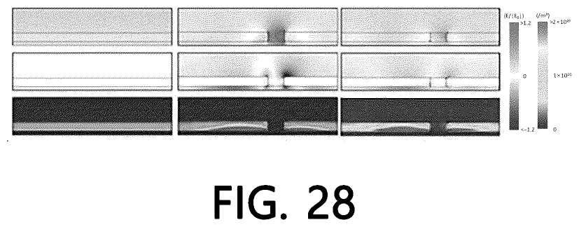

FIG. 27 shows a graph of transmittance for each wavelength for each case. In addition, in the case of FIG. 28, the electric field component mapping and the absorption mapping are performed to measure the surface plasmon resonance phenomenon for the cases 1, 2, and 3 from the left in order. In this case, the upper drawing shows the same Ex electric field element as the incident electric field, the middle drawing shows the Ez electric field element, and the bottom drawing shows the absorption mapping. In addition, the simulation was performed assuming that the light of 500 nm was incident.

As may be seen from FIG. 27, it may be confirmed that the case 3 where the inside of the dendrite is ZnO has a lower transmittance than a uniform thin film at a wavelength of 700 nm or more, and the case 2 where the inside of the dendrite is an empty space has a lower transmittance than a uniform thin film in general across entire wavelength range. In addition, as may be seen from FIG. 28, it may be confirmed that in a generation of the surface plasmon phenomenon, in the case 2 and the case 3, the Ex electric field component changes due to the generation of the surface plasmon phenomenon in the dendrite part unlike the uniform thin film, and the Ez electric field component was observed, and the absorption of the incident light was also improved. In summary, it may be seen that the electrodeposited dendrite has ZnO as its main component, but has a porous structure with empty space inside it, and that the generation of the surface plasmon resonance phenomenon is amplified by this porous structure, thereby achieving a reduction in light transmittance with high electrical efficiency. In conclusion, the dendrite may preferably have a porous structure.

In addition, according to an embodiment of the present disclosure, the dendrite may be characterized in that its average short axis length is 33 nm or more and 175 nm or less. In this case, when the average short axis length is less than 33 nm, resonance by the metal-dielectric-metal structure is not produced, and thus it may be difficult to implement a black color having color neutrality. In the case of the long axis, the average length may be 300 to 800 nm, but when the length is longer than the short axis, the performance of the smart window is not limited to the length of the long axis.

In addition, the electrochromic layer is formed on the substrate by electrodeposition when voltage is applied, and may have a thickness of 5 to 1000 nm. In this case, when the thickness of the electrochromic layer is less than 5 nm, sufficient optical transmission blocking does not occur and heat transfer is not easy, and thus it may be disadvantageous in terms of operating of the smart window, and when the thickness of the electrochromic layer is greater than 1000 nm, voltage drop occurring in the electrolyte becomes excessive, and thus switching efficiency may be disadvantageous compared to controlling the optical transmission.

In addition, according to an embodiment of the present disclosure, the electrochromic layer may include an electrolyte layer, and the electrolyte layer may include a solvent and one or more selected from the group consisting of Zn²⁺, Ag⁺, Cu²⁺, Bi³⁺, and Pb²⁺. More specifically, since Zn²⁺, Ag⁺, Cu²⁺, Bi³⁺, and Pb²⁺ are included in the electrolyte layer, Zn²⁺, Ag⁺, Cu²⁺, Bi³⁺, and Pb²⁺ included in the electrolyte layer may be deposited on the substrate in the form of Zn, Ag, Cu, Bi, Pb, and oxides thereof as the voltage is applied to the substrate, thereby forming nanoparticles or dendrite.

More specifically, the concentration of Zn²⁺, Ag⁺, Cu²⁺, Bi³⁺, and Pb²⁺ may be 200 to 500 mM. In this case, if the concentration of Zn²⁺, Ag⁺, Cu²⁺, Bi³⁺, and Pb²⁺ is less than 200 mM, the dendrite is hardly formed, and thus may be disadvantageous in exhibiting a reduction effect of transmittance due to electrodeposition. In addition, if the concentration of Zn²⁺, Ag⁺, Cu²⁺, Bi³⁺, and Pb²⁺ exceeds 500 mM, the dendrite is formed too much, or a distance between nanoparticles are formed too narrow, and thus generation of a surface plasmon effect is rather suppressed, and thus may be disadvantageous in exhibiting a reduction effect of transmittance.

In this case, the solvent is not limited as long as Zn²⁺, Ag⁺, Cu²⁺, Bi³⁺, and Pb²⁺ may be used as a solvent in a process of electrodepositing Zn, Ag, Cu, Bi, Pb, and oxides thereof, but may be one or more selected from the group consisting of non-aqueous, hydrogen-free, and solubility in salts, such as polar aprotic solvents and ionic liquids, and may be one or more selected from the group consisting of DMSO, acetonitrile, and acrylonitrile. In this case, if the solvent is DMSO, it may be advantageous in terms of price if a solvent from which water is removed is used as much as possible and operated in an appropriate voltage range.

In addition, more specifically, the electrolyte layer may include Zn(CH₃COO)₂, ZnA₂, and BCH₃COO.

In this case, ligand A is one or more selected from the group consisting of F, Cl, Br, and ligand B is one or more selected from the group consisting of Li, Na, and K.

In this case, when the electrolyte layer includes Zn(CH₃COO)₂, ZnA₂, and BCH₃COO, Zn nanoparticles and ZnO dendrite may be deposited more uniformly and smoothly, and thus transmittance may be greatly reduced with less electric energy, and thus it is advantageous in terms of energy efficiency, and is also excellent in that transmittance is uniformly reduced over the entire area of the smart window as it is uniformly deposited. In addition, due to its uniformity, transmittance is uniformly reduced over the entire wavelength range during deposition, which is advantageous in that excellent black may be achieved even with less electric energy. In this case, preferably, ligand A may be Br, ligand B may be Na, and when ligand A is Br and ligand B is Na, it may be more advantageous in terms of electrical efficiency and excellent black achieving compared to otherwise.

In addition, in an embodiment of the present disclosure, the concentration of Zn(CH₃COO)₂ may be 10 to 500 mM, the concentration of ZnA₂ may be 10 to 500 mM, and the concentration of BCH₃COO may be 10 to 500 mM, and, in embodiments, the concentration of Zn(CH₃COO)₂ may be 200 to 500 mM, the concentration of ZnA₂ may be 200 to 500 mM, and the concentration of BCH COO may be 200 to 500 mM.

In this case, if the concentration of Zn(CH₃COO)₂ is out of 10 to 500 mM, the concentration of ZnA₂ is out of 10 to 500 mM, and the concentration of BCH₃COO is out of 10 to 500 mM, the concentration may be too low so that nanoparticles are not properly formed, thereby reducing the transmittance reduction efficiency during electrodeposition, or the concentration may be too high so that the dendrite and nanoparticles are excessively formed, thereby preventing the surface plasmon effect from being generated, resulting in a state similar to a metal thin film, or excessive oxide formation may also occur, thereby reducing the transmittance reduction efficiency. In this case, the concentration of Zn(CH₃COO)₂ may be 200 to 500 mM, the concentration of ZnA₂ may be 200 to 500 mM, and the concentration of BCH₃COO may be 200 to 500 mM, and in this case, nanoparticles and dendrite are formed in an appropriate ratio, so that the generation of the surface plasmon effect is maximized, and accordingly, the transmittance reduction efficiency may also be maximized.

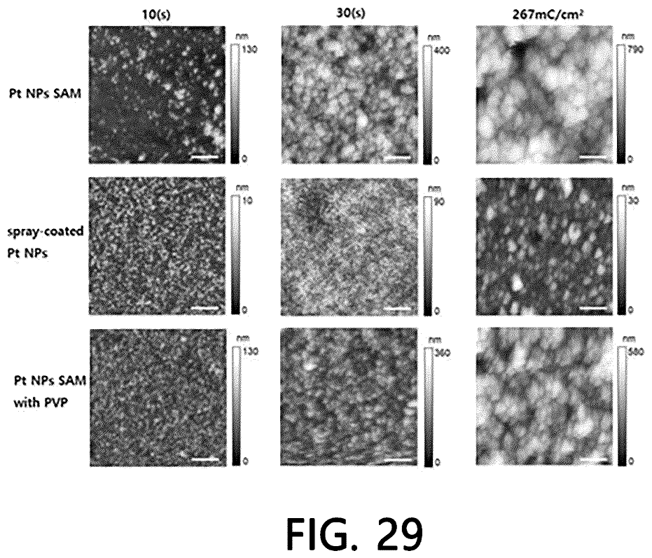

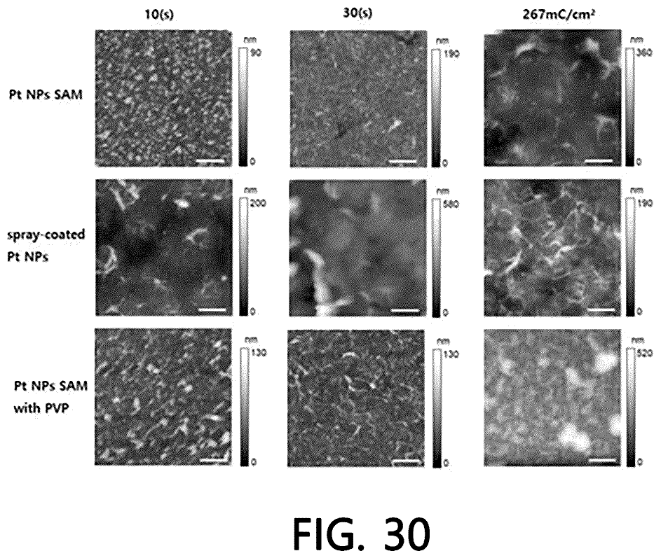

More specifically, it will be described with reference to FIGS. 29 and 30.

FIG. 29 shows the results obtained by atomic force microscopy (AFM) of a case in which a DMSO solution containing Zn(CH₃COO)₂ of 50 mM, ZnBr₂ of 50 mM, and NACH₃COO of 67 mM in FIGS. 1A-IC was used as the electrolyte, and the electrodes were Pt NPs SAM, spray-coated Pt NPs, and Pt NPs SAM with PVP, respectively, and were electrodeposited at a charge density of 10 seconds, 30 seconds, and 267 mC/cm², respectively, and FIG. 30 shows the results obtained by AFM of a case in which a DMSO solution containing Zn(CH₃COO)₂ of 300 mM, ZnBr₂ of 300 mM, and NACH₃COO of 400 mM in FIGS. 16A-16C was used as the electrolyte, and the electrodes were Pt NPs SAM, spray-coated Pt NPs, and Pt NPs SAM with PVP, respectively, and were electrodeposited at a charge density of 10 seconds, 30 seconds, and 267 mC/cm², respectively.

As may be seen from FIGS. 29 and 30, when the concentration of Zn(CH₃COO)₂ is 200 to 500 mM, the concentration of ZnBr₂ is 200 to 500 mM, and the concentration of ACH₃COO is 200 to 500 mM, it may be confirmed that the dendrite is formed more smoothly than in the other case, and in this case, as described above, due to the generation of the surface plasmon effect by the dendrite, the light transmittance may be lower than that of an ideal thin film assuming electrodeposition at the same charge density, and at the same time, the decrease in transmittance is constant across the entire wavelength range, which may be advantageous in forming excellent black. Therefore, when the concentration of Zn(CH₃COO)₂ is 200 to 500 mM, the concentration of ZnBr₂ is 200 to 500 mM, and the concentration of ACH₃COO is 200 to 500 mM, the electrical efficiency is very excellent in the operation of the smart window, and it may be advantageous in the formation of excellent black.

More specifically, the electrolyte layer may further include one or more polymers selected from the group of polymers commonly used as a capping agent, and preferably further include one or more polymers selected from the group consisting of polyvinylpyrrolidone (PVP), cetyltrimethylammonium bromide (CTAB), cetyltrimethylammonium chloride (CTAC), polyethylene glycol (PEG), ethylenediaminetetraacetic acid (EDTA), and bovine serum albumin (BSA), and, in embodiments, further include PVP. In this case, when the polymer is included in the electrolyte layer, the formation of a biproduct is blocked and the deposition condition is induced by diffusion-limitation, and thus a transmittance reduction effect similar to or better than that when the polymer is not included may be achieved even with less electrical energy, and thus may be excellent in terms of electrical efficiency. More specifically, referring to FIGS. 18 to 20, it may be confirmed that in the case where PVP is included in the electrolyte layer, a lower charge density is consumed compared to other cases, but a similar level of transmittance is shown.

More specifically, in order to form the electrolyte layer in a gel form, the electrolyte layer may further include one or more selected from the group consisting of hydroxyethyl cellulose, polyvinyl acetate (PVA), and polyvinyl butyral (PVB). More specifically, through this, the electrolyte layer in a solution form may be converted into a gel form, and thus it may be advantageous because it is easy to block a uniform color through ion diffusion limitation, and to handle in the smart window manufacturing process.

In addition, the voltage applied to the electrodeposition smart window according to the present disclosure may be −1 to 1.5 V. In this case, when the applied voltage is lower than −1 V or greater than 1.5 V, electrolysis of automatically hydrated water vapor or electrolysis of the electrolyte may occur.

In addition, more specifically, the smart window according to the present disclosure may further include a counter electrode. In this case, the counter electrode may be electrically connected to the substrate according to the present disclosure.

In addition, more specifically, the counter electrode may include the same metal as the metal included in the deposited nanoparticles as its component. For example, when the nanoparticles are composed of Zn, the counter electrode may include Zn.

Also, more specifically, the counter electrode is not limited as long as it is usually used in the electrode of the smart window, but more specifically, it may have a mesh shape or a frame shape in which a center portion is empty to secure transparency.

More specifically, the smart window according to the present disclosure may further include a transparent base material located on the opposite side of a substrate. In this case, the electrochromic layer and the counter electrode may be located between the transparent base material located opposite to the substrate and the substrate. In this case, the transparent base material located opposite to the substrate is not limited as long as it is usually used as an external base material of the smart window, but more specifically, it may be one or more selected from the group consisting of glass, PET, and PES. In addition, the smart window according to the present disclosure may further include a base material surrounding and sealing the edge of the transparent base material located on the opposite side of the substrate and the substrate so that the electrochromic layer does not leak to the outside. The corresponding substrate is not limited as long as it is usually used as the edge of the smart window.

Also, the transparent base material located opposite to the substrate is not limited in its thickness and may be variously selected depending on the application, but may be, for example, 0.1 to 10000 mm.

More specifically, the smart window according to the present disclosure may further include components usually constituting the smart window in addition to the above components.

In conclusion, the present disclosure provides an electrically efficient electrodeposition smart window in which, when voltage is applied, nanoparticles and/or dendrite are deposited, thereby causing a surface plasmon effect to be generated, thereby effectively absorbing the incident light, thereby achieving a high transmittance reduction effect even with less electrical energy. In addition, the smart window according to the present disclosure may be very advantageous in achieving excellent black since the transmittance is uniformly reduced across the entire wavelength range when voltage is applied. This is very excellent as it is very difficult to technically implement excellent black in a comparative smart window, and also a lot of electrical energy was required to achieve low light transmittance or that electrical energy had to be continuously applied, resulting in poor electrical efficiency.

What is claimed is:

1. An electrodeposition smart window comprising:
a substrate; and
an electrochromic layer formed on the substrate, and
wherein the electrochromic layer includes a nanoparticle layer including nanoparticles electrodeposited on the substrate when voltage is applied.

2. The electrodeposition smart window of claim 1, wherein the nanoparticle layer is configured such that an average radius of the nanoparticles is 20 to 120 nm.

3. The electrodeposition smart window of claim 1, wherein the nanoparticle layer is configured such that an average distance between the nanoparticles is greater than twice and less than or equal to four times an average radius of the nanoparticles.

4. The electrodeposition smart window of claim 1, wherein the nanoparticles includes one or more selected from the group consisting of Zn, Ag, Cu, Bi, and Pb.

5. The electrodeposition smart window of claim 1, further comprising:
a dendrite formed inside or on the nanoparticle layer.

6. The electrodeposition smart window of claim 5, wherein the dendrite is a porous structure.

7. The electrodeposition smart window of claim 5, wherein the dendrite is one or more selected from the group consisting of Zn, Ag, Cu, Bi, Pb and oxides of Zn, Ag, Cu, Bi, and Pb.

8. The electrodeposition smart window of claim 5, wherein the dendrite is configured such that its average short axis length is 33 nm or more and 175 nm or less.

9. The electrodeposition smart window of claim 1, wherein the substrate includes:
a transparent base material; and
a transparent conductive material coated on the transparent base material,
wherein the transparent base material is one or more selected from the group consisting of glass, polyester (PET), and polyether sulfone (PES), and
the transparent conductive material is one or more selected from the group consisting of InSnO (ITO), InZnO, ZnO, InZnSnO, TiInZnO, NiInZnO, AZO(Al-doped ZnO), BZO(B-doped ZnO), and Ga-doped ZnO (GZO).

10. The electrodeposition smart window of claim 9, wherein the substrate further includes inert metal nanoparticles coated on the transparent conductive material, and
wherein the inert metal nanoparticles are one or more selected from the group consisting of Pt, Au, Ru, Rh, Pd, Os, and Ir.

11. The electrodeposition smart window of claim 9, wherein the transparent conductive material has a thickness of 50 to 350 nm, and the electrochromic layer has a thickness of 10 to 1000 nm.

12. The electrodeposition smart window of claim 1, wherein the electrochromic layer includes an electrolyte layer, and
the electrolyte layer includes a solvent and one or more selected from the group consisting of Zn²⁺, Ag⁺, Cu²⁺, Bi³⁺, and Pb²⁺.

13. The electrodeposition smart window of claim 12, wherein the electrolyte layer includes Zn(CH₃COO)₂, ZnA₂, and BCH₃COO,
wherein ligand A is one or more selected from the group consisting of F, Cl, Br, and ligand B is one or more selected from the group consisting of Li, Na, and K.

14. The electrodeposition smart window of claim 13, wherein the Zn(CH₃COO)₂ has a concentration of 10 to 500 mM, and
the ZnA₂ has a concentration of 10 to 500 mM.

15. The electrodeposition smart window of claim 13, wherein the Zn(CH₃COO)₂ has a concentration of 200 to 500 mM, and
the ZnA₂ has a concentration of 200 to 500 mM.

16. The electrodeposition smart window of claim 12, wherein the electrolyte layer further includes one or more selected from the group consisting of polyvinylpyrrolidone (PVP), cetyltrimethylammonium bromide (CTAB), cetyltrimethylammonium chloride (CTAC), polyethylene glycol (PEG), ethylenediaminetetraacetic acid (EDTA), and bovine serum albumin (BSA).

17. The electrodeposition smart window of claim 12, wherein a current density applied until a transmittance reaches 10% at 400 to 800 nm is always lower than that of the case of a metal thin film including the same amount of Zn, Ag, Cu, Bi, and Pb.

18. The electrodeposition smart window of claim 1, wherein the applied voltage is −1 to 1.5 V.
